(19) United States
(12) Patent Application Publication
(10) Pub. No.: US 2015/0024688 A1
(43) Pub. Date: Jan. 22, 2015

(54) Automatic Pairing of a Vehicle and a Mobile Communications Device

(71) Applicant: GM Global Technology Operations LLC, Detroit, MI (US)

(72) Inventors: Robert A. Hrabak, West Bloomfield, MI (US); Wen Gu, Sterling Heights, MI (US); Karen Juzswik, Ypsilanti, MI (US)

(73) Assignee: GM Global Technology Operations LLC, Detroit, MI (US)

(21) Appl. No.: 14/287,594

(22) Filed: May 27, 2014

Related U.S. Application Data
(63) Continuation-in-part of application No. 13/943,128, filed on Jul. 16, 2013.

(51) Int. Cl. H04W 4/00; H04W 48/14

(52) U.S. Cl. CPC H04W 4/008; H04W 48/14
USPC 455/41.2

(57) ABSTRACT

A method of associating a second vehicle with a mobile communications device is provided. The method authenticates a user with the second vehicle. The method retrieves user information of the user from a remote server. The user information includes an identifier of a mobile communications device. The identifier of the mobile communications device has been previously sent to the remote server by a first vehicle and stored at the remote server. The method automatically associates with the mobile communications device based on the retrieved user information.

### CROSS-REFERENCE TO RELATED APPLICATIONS

This application is a Continuation-in-Part of U.S. Non-Provisional patent application Ser. No. 13/943,128, filed Jul. 16, 2013 which is incorporated herein, by reference, in its entirety.

### BACKGROUND

The subject invention relates to wireless pairing and, more particularly, to automatic pairing of a vehicle and a mobile device, to authenticate wireless communications between the mobile device and the vehicle.

Mobile communications devices, such as smartphones, are advanced devices that offer greater functionality than the telephony features provided by their predecessors. Currently, these advanced mobile devices provide the ability to run complex applications based on a particular platform. There has been an increasing growth in demand for smartphones due to their advanced computer processing capabilities.

With the prevalence of smartphones, many users expect their smartphones, or other mobile communications devices, to be able to communicate with their vehicle. For example, it is desirable for phone calls to be placed or received in a hands-free fashion through the vehicle's audio system when a phone is inside the vehicle. This type of integration requires secure, reliable communications between the phone, or other mobile communications device, and the vehicle. While some vehicles now offer wireless communications between devices and the vehicle, the associated set-up processes can be cumbersome.

It is desirable to enable simplified and secure wireless communications between a mobile communications device and a vehicle.

### SUMMARY OF THE INVENTION

In one exemplary embodiment of the invention, a method of associating a second vehicle with a mobile communications device is provided. The method authenticates a user with the second vehicle. The method retrieves user information of the user from a remote server. The user information includes an identifier of a mobile communications device. The identifier of the mobile communications device has been previously sent to the remote server by a first vehicle and stored at the remote server. The method automatically associates with the mobile communications device based on the retrieved user information.

In another exemplary embodiment of the invention, a system comprising a computer processor and logic executable by the computer processor, the logic configured to implement a method is provided. The method receives, from a first vehicle, user information including an identifier of a mobile communications device. The method stores the user information. The method receives, from a second vehicle, a request for the user information. The method sends the second vehicle the user information. The second vehicle automatically associates with the mobile communications device based on the user information.

In yet another exemplary embodiment of the invention, a method of facilitating automatic association of a second vehicle and a mobile communications device is provided. The method authenticates, by a first vehicle, a user with the first vehicle. The method obtains an identifier of the mobile communications device. The method sends user information including the identifier of the mobile communications device to a remote server. The remote server subsequently sends the user information to the second vehicle in response to receiving a request from the second vehicle. The second vehicle automatically associates with the mobile communications device when the user brings the mobile communications device to the second vehicle.

The above features and advantages, as well as other features and advantages, of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a system upon which secured wireless pairing and communications between a mobile communications device and a vehicle may be implemented in accordance with an exemplary embodiment;

FIG. 2 depicts a network access device for implementing the secured wireless pairing and communications in accordance with an exemplary embodiment;

FIGS. 3A-3D are flow diagrams describing processes for implementing secured wireless pairing and communications between a mobile communications device and a vehicle in accordance with exemplary embodiments;

FIG. 4 depicts a system upon which a telematics system provider facilitates an automatic pairing process between a mobile communications device and a vehicle; and

FIG. 5 depicts a process flow for facilitating an automatic pairing process between a mobile communications device and a vehicle.

### DESCRIPTION OF THE EMBODIMENTS

The following description is merely exemplary in nature and is not intended to limit the present disclosure, its application or uses.

In accordance with an exemplary embodiment of the invention, secure simple pairing and wireless communications between a mobile communications device and a vehicle are provided. The exemplary processes establish secure wireless communications between the mobile communications device and a network access device embedded in the vehicle. A telematics system (such as OnStar®) of the vehicle is used to bootstrap the trust between the mobile communications device and the vehicle.

A pairing process is performed between the mobile communications device and the network access device of the vehicle using information gained by the mobile communications device about the vehicle. Once the pairing process is completed, the network access device of the vehicle initiates a connection with the mobile communications device over a short-range wireless network, and a user of the mobile communications device may implement vehicle functions, such as remote starting of the vehicle, through the mobile communications device in lieu of a key or a fob.

In accordance with another exemplary embodiment of the invention, a telematics service provider facilitates an automatic pairing process between a mobile communications device and a second vehicle when a pairing process has been previously performed between the mobile communications device and a first vehicle. Specifically, the first vehicle sends a unique identifier of the mobile communications device to the telematics service provider when the pairing process is successfully completed between the first vehicle and the mobile communications device. The telematics service provider sends this unique identifier to the second vehicle upon receiving a request from the second vehicle. The second vehicle sends the request to the telematics service provider when a user carrying the mobile communications device accesses the second vehicle. The second vehicle obtains the unique identifier and uses it to establish a wireless connection between the second vehicle and the mobile communications device. Manual user intervention is not necessary for the second vehicle to establish the wireless connection. These and other features of the exemplary processes will now be described.

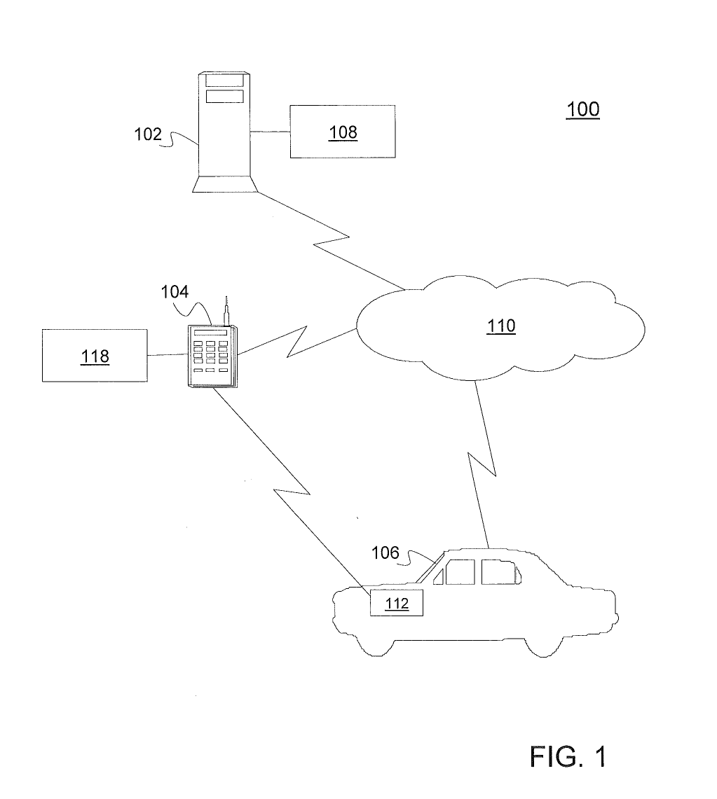

Turning now to FIG. 1, a system 100 upon which secure simple pairing and wireless communications between a mobile communications device and a vehicle may be implemented will now be described in an exemplary embodiment.

The system 100 includes a telematics service provider computer 102, a vehicle 106, and a mobile communications device 104 of a user of vehicle 106 (e.g., an owner or operator of vehicle 106). Vehicle 106 supports wireless connectivity of onboard mobile devices through an embedded network access device 112. In an embodiment, Bluetooth® is used for such wireless connectivity. Bluetooth® pairing, or establishing secure wireless communications, can be accomplished, for example, via Secure Simple Pairing (SSP).

The exemplary processes authenticate two communicating devices using a trusted third-party or “out-of-band” medium. In particular, vehicle 106 hosts a Bluetooth® network which the mobile communications device 104 desires to join. The mobile communications device 104 is presumed to be within, or in close proximity to, vehicle 106. Vehicle 106 has access to the telematics service provider computer 102, such as OnStar®, via a cellular service provider, which may be one of networks 110. The mobile communications device 104 may receive phone and data services through a cellular service provider, which may be the same service provider as the cellular service provider of vehicle 106 or may be different. The cellular service provider(s) communicate with the Internet (e.g., one of networks 110), from which the telematics service provider computer 102 may be reached. With this architecture, the wireless communication trust between vehicle 106 and the mobile communications device 104 can be bootstrapped, or self-enabled, by using the telematics service provider computer 102 as a trusted out-of-band medium.

In the system 100, it is assumed that both of the cellular communication links—from vehicle 106 to the cellular service provider (e.g., one of networks 110), and from the mobile communications device 104 to the cellular service provider (e.g., one of the networks 110)—are secure. It is also assumed that the communication links from the cellular service provider to the Internet, and from the telematics service provider computer 102 to the Internet, are secure.

The telematics service provider computer 102 may be implemented as a high-speed computer processing device (e.g., a mainframe computer) capable of handling a high volume of activities conducted between the computer 102 and the network entities (e.g., mobile communications device 104 and network access device 112 in vehicle 106 shown in FIG. 1). The telematics service provider computer 102 may operate as a web server including a web site for generating subscription accounts for vehicle manufacturers and/or dealerships, as well as for providing access to secure pairing information to users or consumers of telematics services. In an embodiment, the telematics service provider computer 102 implements logic 108 for communicating with both the mobile communications device 104 and vehicle 106 (e.g., receiving vehicle information from the mobile communications device 104 and forwarding the information on to vehicle 106). In addition, the logic 108 is configured to generate and transmit authentication values to the mobile communications device, as will be described further herein.

The mobile communications device 104 may be a cellular telephone with enhanced functionality (e.g., a smartphone). The mobile communications device 104 includes memory and communication components. The memory may store and execute one or more applications typically associated with a mobile communications device (e.g., text messaging application, web browser, contacts/address folder, voicemail, etc.). The communication components enable the mobile communications device 104 to communicate over one or more networks, such as networks 110. The mobile communications device 104 is configured with various communication protocols for enabling the communications through its communication components. For example, the protocols may include Wi-Fi, Bluetooth Smart® low energy (“BLE”) protocol, and cellular communication protocols.

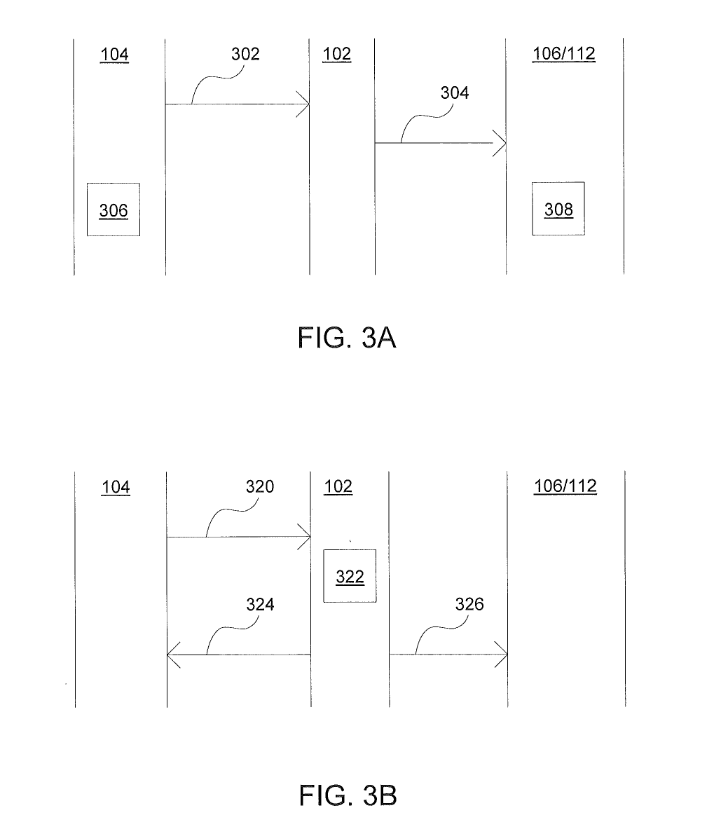

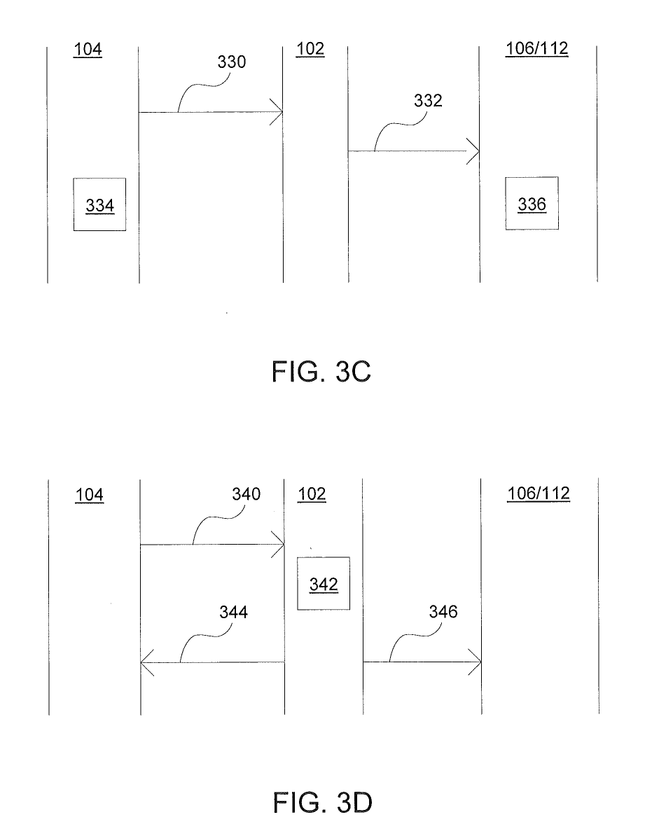

As indicated above, the mobile communications device 104 implements various applications, such as a web browser, text messaging application, etc. In an embodiment, the mobile communications device 104 also executes an application or logic 118 for initiating a pairing feature of the secure pairing described herein. The pairing feature is described further in FIGS. 3A-3D. Logic 118 may include a user interface, which may be provided to the user via a display panel of the mobile communications device 104. The pairing feature may include an encryption algorithm for facilitating a secured pairing between the mobile communications device 104 and the network access device 112 of vehicle 106. In one embodiment, the mobile communications device 104 includes a scanner (not shown) configured to scan, e.g., universal product codes (UPCs) and/or quick response (QR) codes, as will be described further herein.

Vehicle 106 may include various vehicle components, such as a passive-entry passive-start (PEPS) module and related circuitry and antennae, as well as a central controller that manages the communications across the vehicle's network (e.g., a local area network). These components are well understood by those skilled in the art and will not be further discussed.

The networks 110 may include a combination of networks (e.g., cellular, satellite, terrestrial), and may include local area networks, wide area networks, and the Internet).

As indicated above, the exemplary secure simple pairing and wireless communications processes provide additional functionality to the mobile communications device 104, such as enabling the remote start of vehicle 106 in lieu of a key or a fob. A pairing process is performed between the mobile communications device 104 and the network access device 112 of vehicle 106, using information gained by the mobile communications device 104 about vehicle 106. Once the pairing process has been successfully completed, the network access device 112 initiates a connection with the mobile communications device 104 over a short-range wireless network, such as Bluetooth®, and the mobile communications device 104 can initiate a vehicle start up absent the need for a key or key fob.

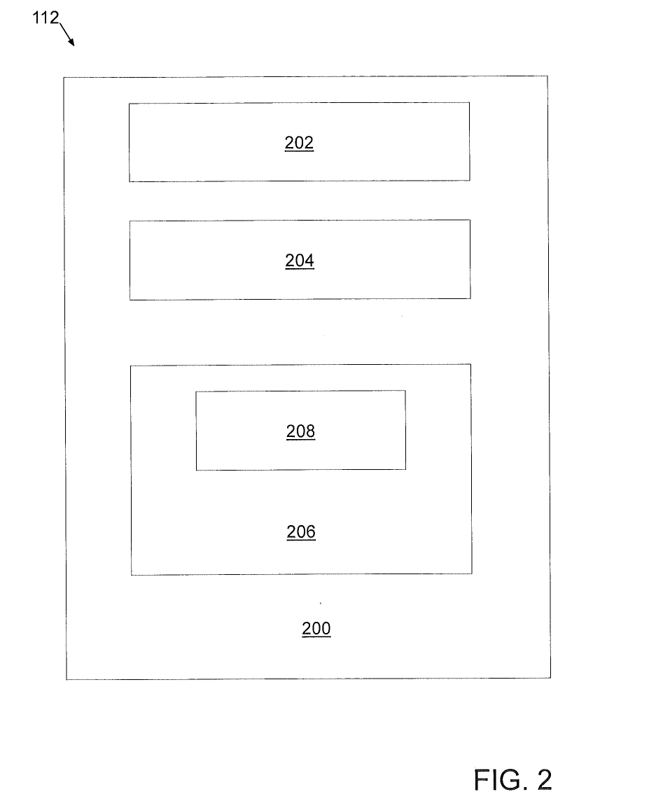

Turning now to FIG. 2, a network access device 200 for implementing secure simple pairing and wireless communications will now be described in an exemplary embodiment. The network access device 200 corresponds to the network access device 112 of FIG. 1.

The network access device 112 may include telematics system components embedded in vehicle 106. The network access device 112 includes communications components 202, such as an antenna, a computer processor 204, memory 206, and logic 208 stored in the memory 206 and executable by the computer processor 204. The communications components 202 are configured to communicate over a short-range wireless network using radio frequency signaling. The communications components may be Bluetooth-enabled components.

The logic 208 is configured to process data received from the mobile communications device 104 and the telematics service provider computer 102, as will be described further herein.

Turning now to FIGS. 3A-3D, flow diagrams describing processes for secure pairing and wireless communications in accordance with an exemplary embodiment will now be described. For purposes of illustration, it is assumed that the user of the mobile communications device 104 has purchased vehicle 106 and is ready to pair his/her mobile communications device 104 to vehicle 106. In one embodiment, vehicle information used in the pairing process is provided to the user, e.g., at the time of vehicle purchase. The vehicle information may include one or more of a vehicle identification number (VIN), a mobile equipment identifier of the network access device 112, a phone number of the network access device 112, and a telematics service account identifier associated with vehicle 106.

In one embodiment, the vehicle information may be relayed to the mobile communications device 104 via encoded information (e.g., UPC or QR code) on a tag or paper associated with vehicle 106. In another embodiment, the vehicle information may be transmitted to the user's mobile communications device 104, or to the telematics service provider computer 102 servicing vehicle 106, over the networks 110.

In FIG. 3A, the mobile communications device 104 acquires the vehicle information and sends (302) the information to the telematics service provider computer 102. The telematics service provider computer 102 identifies vehicle 106 from the information and forwards (304) the information on to vehicle 106. At this point, both the mobile communications device 104 and vehicle 106 have the necessary information to establish (306 and 308, respectively) an authentication value (e.g., link key) for use in pairing the mobile communications device 104 to vehicle 106.

In FIG. 3B, the mobile communications device 104 acquires the vehicle information and sends (320) the information as a payload (e.g., a cellular packet) to the telematics service provider computer 102. The telematics service provider computer 102 identifies vehicle 106 from the information, generates (322) an authentication value (e.g., link key), and sends (324) the authentication value to the mobile communications device 104 and also sends (326) the authentication value to vehicle 106.

In FIG. 3C, the mobile communications device 104 acquires the vehicle information and sends (330) the information to the telematics service provider computer 102 as a text message. The telematics service provider computer 102 identifies vehicle 106 from the information and forwards (332) the text message on to vehicle 106. At this point, both the mobile communications device 104 and vehicle 106 have the necessary information to establish (334 and 336, respectively) an authentication value (e.g., link key) for use in pairing the mobile communications device 104 to vehicle 106.

In FIG. 3D, the mobile communications device 104 acquires the vehicle information and sends (340) the information as a text message to the telematics service provider computer 102. The telematics service provider computer 102 identifies vehicle 106 from the information, generates (342) an authentication value (e.g., link key), and sends (344) the authentication value to the mobile communications device 104 and also sends (346) the authentication value to vehicle 106.

In an embodiment, the logic 118 of the mobile communications device 104 creates seed information for generating the authentication value. The logic 118 may encrypt a unique identifier of the mobile communications device 104 before sending the vehicle information and the unique identifier to the telematics service provider computer 102. In an embodiment, the unique identifier is a Bluetooth® network address of the mobile communications device 104. The seed information may also be encrypted.

Once the authentication value is received by vehicle 106, or alternatively, once the value has been generated by vehicle 106, the network access device 112 stores the authentication value in the memory 206, FIG. 2.

The network access device 112 initiates a connection with the mobile communications device 104 over a short-range wireless communications network. Once this pairing process has completed, the mobile communications device 104 may initiate various functions for implementation by the vehicle, e.g., remote start when the devices are in communicative range of one another.

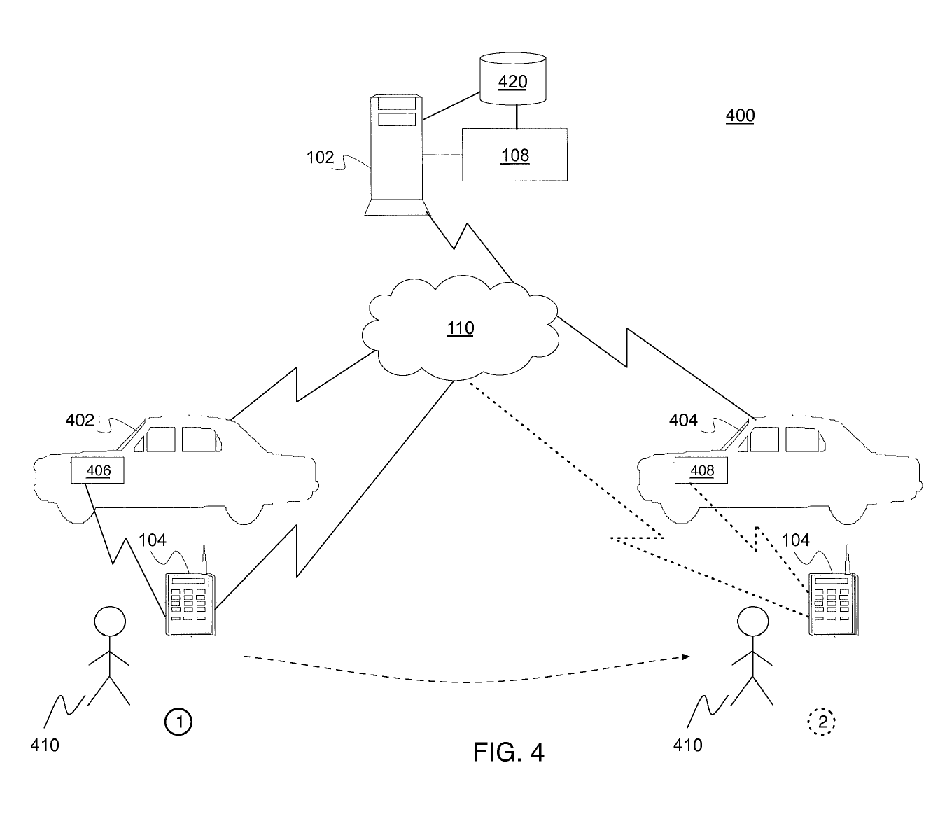

FIG. 4 illustrates a system 400 upon which a telematics system provider facilitates an automatic pairing process between a mobile communications device and a vehicle when a pairing process has been previously performed between the mobile communications device and another vehicle. The system 400 includes the telematics service provider computer 102, vehicles 402 and 404, and the mobile communications device 104.

The telematics service provider computer 102, as described above by reference to FIG. 1, provides various different services to vehicles that are equipped with telematics systems. In particular, the telematics service provider computer 102, in an embodiment, maintains user profiles 420 of users who may each operate one or more of the vehicles equipped with telematics systems that are configured to use the services provided by the telematics service provider computer 102. In an embodiment, a user profile of a user includes a list of unique identifiers (e.g., Bluetooth® Address (BD_ADDR), Media Access Control (MAC) address, etc.) of the mobile communications devices that the user uses. In an embodiment, the logic 108, described above by reference to FIG. 1, is also configured to maintain the user profiles 420 and process any requests from the vehicles.

In an embodiment, the telematics service provider computer 102 obtains a unique identifier of a mobile communications device from a vehicle equipped with a telematics system when the vehicle successfully performs a pairing process between a mobile communications device and the vehicle. Alternatively or conjunctively, the telematics service provider computer 102 may obtain a unique identifier of a mobile communications device directly from the user or the mobile communications device when the user registers with the telematics service provider and creates a user profile in the telematics service provider computer 102. As can be recognized, the telematics service provider computer 102 may obtain unique identifiers of the user's mobile communications devices in many different ways.

In an embodiment, the telematics service provider computer 102 provides a list of mobile communications devices of a user to a vehicle equipped with a telematics system upon receiving a request from the vehicle. In an embodiment, the vehicle requests the list when the vehicle successfully authenticates a user to the vehicle and notifies the telematics system provider computer 102 of the successful user authentication. The vehicle uses the list of mobile communications devices to recognize a mobile communications device when the user carrying the device accesses the vehicle.

In an embodiment, the telematics service provider computer 102 is not necessarily a single physical computer. That is, the telematics service provider computer may be one of many computers (not shown) that access the user profiles 420 and implement the logic 108 in a distributed fashion. In an embodiment, these computers operate in a cloud computing environment for the telematics service provider.

The mobile communications device 104, as described above by reference to FIG. 1, may be a cellular telephone with enhanced functionality (e.g., a smartphone). In an embodiment, the mobile communications device 104 may also be any mobile device (e.g., a personal media player, a tablet computer, a laptop computer, a wearable electronic device such as a smart watch and a smart medical device, etc.) that can join the wireless network hosted by a vehicle 402, 404. Also as described above, the mobile communications device 104 executes an application or logic 118 (not shown in FIG. 4). The mobile communications device 104 may be brought to and removed from vehicle 402, 404 by a user 410.

Vehicles 402 and 404, like vehicle 106 described above by reference to FIG. 1, are equipped with network access devices. As shown, vehicle 402 includes a network access device 406, and vehicle 404 includes a network access device 408. Vehicles 402 and 404 also support wireless connectivity of onboard mobile communications devices through the network access devices 406 and 408, respectively. The network access devices 406 and 408 are similar to the network access device 112, described above by reference to FIG. 1, in that each of the network access devices 406 and 408 corresponds to the network access device 200 described above by reference to FIG. 2. As can be recognized, there are many different wireless network standards that vehicles 402 and 404 may each employ to host a wireless network for wireless communication with the mobile communications device 104. Examples of the wireless network standards include Wi-Fi and Bluetooth®.

Like vehicle 106, vehicles 402 and 404 have access to the telematics service provider computer 102, via a cellular service provider, which may be one of networks 110. The cellular service provider(s) communicate with the Internet (e.g., one of networks 110), from which the telematics service provider computer 102 may be reached. In the system 400, it is assumed that both of the cellular communication links from vehicles 402 and 404 to the cellular service provider (e.g., one of networks 110) are secure.

Unlike vehicle 106, however, it is assumed that neither of vehicles 402 and 404 has bootstrapped the trust between the mobile communications device 104 and the vehicles. That is, the mobile communications device 104 has not acquired the vehicle information of vehicles 402 and 404, and vehicles 402 and 404 do not have information about the mobile communications device 104. It is, however, assumed that the user 410 of the mobile communications device 104 has previously set up a user profile in the telematics service provider computer 102. For example, the user may have set up a user profile when the user purchased vehicle 106.

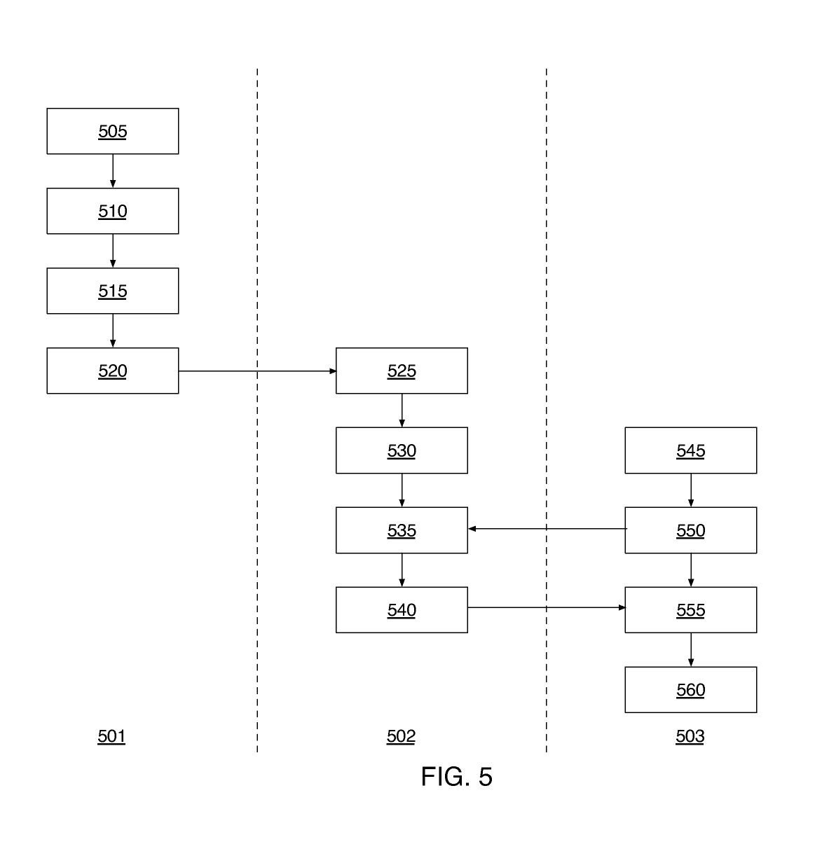

An example operation of the system 400 will now be described by reference to FIG. 5, with a continued reference to FIG. 4. FIG. 5 depicts a process flow for facilitating an automatic pairing process between a mobile communications device and a vehicle. Specifically, in an embodiment, blocks 505-520 in column 501 of the process flow shown in FIG. 5 are performed by vehicle 402, blocks 525-540 in column 502 are performed by the telematics service provider computer 102, and the blocks 545-560 in column 503 are performed by vehicle 404.

At block 505, vehicle 402 performs an authentication process to authenticate the user 410. In this example operation, the user 410 carrying the mobile communications device 104 has accessed vehicle 402. In an embodiment, vehicle 402 performs the authentication process in order to determine whether the user 410 is authorized to use vehicle 402 and/or to access the telematics service provider computer 102. Vehicle 402 maintains the information necessary to authenticate the user locally at vehicle 402. Alternatively or conjunctively, in an embodiment, the telematics service provider computer 102 maintains the information to authenticate the user. In such an embodiment, vehicle 402 relays user-provided information (e.g., username and password) received from the user 410 to the telematics service provider computer 102, and the telematics service provider computer 102 authenticates the user 410.

Vehicle 402 may employ one or more of or a combination of many different authentication mechanisms to authenticate the user. For example, vehicle 402 may have an on-board display through which the user may enter a username-password pair or a passcode. As another example, vehicle 402 may also employ biometric sensors (not shown) to collect and use the user's biometric data (e.g., the user's retina, fingerprints, voice, face, etc.) to authenticate the user. As another example, vehicle 402 may also rely on a key or a fob to authenticate the user. As can be recognized, numerous other authentication mechanisms available currently or in the future may be employed by vehicle 402. In this example operation, it is assumed that the user is successfully authenticated.

At block 510, vehicle 402, specifically the network access device 406 of vehicle 402, performs a pairing process or an association process to allow the mobile communications devices to join a wireless network hosted by vehicle 402. For the purpose of discussion, vehicle 402 is assumed to be a conventional vehicle that does not implement the embodiments of the invention. Under such assumption, the pairing process requires an associated set-up process that could be complex and cumbersome. As can be recognized, such a set-up process involves various different steps that depend on the wireless network standards. For example, during the set-up process, the user has to turn on searching features of vehicle 402 and/or the mobile communications device 104 to search for each other, and then has to verify and/or enter additional information (e.g., a PIN number) on the vehicle and/or the mobile communications device. As another example, during the set-up process, the user has to find a unique identifier (e.g., a media access control (MAC) address) of the mobile communications device 104 and has to manually enter it to vehicle 402. Once the pairing process is successfully completed, the network access device 406 of vehicle 402 initiates a connection with the mobile communications device over the wireless network.

During the pairing process, vehicle 402 of an embodiment of the invention obtains a unique identifier from the mobile communications device 104. At block 515, vehicle 402 stores the unique identifier of the mobile communications device 104 in a user profile of the user 410 that vehicle 402 maintains. Subsequently, vehicle 402 of an embodiment of the invention does not have to perform the pairing process again and can initiate a connection with the mobile communications device 104 over the wireless network.

At block 520, vehicle 402 sends the unique identifier of the mobile communications device 104 to the telematics service provider computer 102. In an embodiment, vehicle 402 sends the unique identifier by synchronizing the user profile with the corresponding user profile of the user profiles 420 maintained by the telematics service provider computer 102.

As mentioned above, in an embodiment, the blocks 525-540 are performed by the telematics service provider computer 102. At block 525, the telematics service provider computer 102 receives the unique identifier of the mobile communications device 104 from vehicle 402. In an embodiment, the telematics service provider computer 102 receives the user profile of the user 410 that includes the unique identifier of the user 410.

At block 530, the telematics service provider computer 102 stores the unique identifier of the mobile communications device 104. In an embodiment, the telematics service provider computer 102 adds the received unique identifier to the list of mobile communications devices in the user profile of the user 410 maintained by the telematics service provider computer 102 maintains.

At block 535, the telematics service provider computer 102 receives, from vehicle 404, a request for a list of mobile communications device that the user 410 uses. In this example operation, the telematics service provider computer 102 receives the request from vehicle 404 after the user 410 leaves vehicle 402, and accesses vehicle 404, as indicated by the encircled numbers 1 and 2 illustrated in FIG. 4. It is also assumed that the user 410 has been successfully authenticated to use vehicle 404 and/or to access the telematics service provider computer 102. In an embodiment, the request includes the user identifier of the user 410, which the telematics service provider computer 102 uses to locate the user profile of the user 410 among the user profiles 420.

At block 540, the telematics service provider computer 102 sends the unique identifier of the mobile communications device 104 to vehicle 404. In an embodiment, the telematics service provider computer 102 sends the user profile of the user that includes a list of mobile communications devices that the user 410 can use, to vehicle 404.

As mentioned above, the blocks 545-560 are performed by vehicle 404, and the user 410 has accessed vehicle 404, as indicated by the encircled numbers 1 and 2 illustrated in FIG. 4. At block 545, vehicle 404 performs an authentication process to authenticate the user 410. In an embodiment, the authentication process that vehicle 404 performs at block 545 is similar to the authentication process that vehicle 402 performs at block 505. As mentioned above, it is assumed that the user is successfully authenticated with vehicle 404 and/or the telematics service provider computer 102. Once the user is successfully authenticated, vehicle 404 may search for the user profile of the user 410. If the user profile of the user 410 is found, vehicle 404 looks for a list of mobile communications devices that the user 410 uses. In an embodiment, the network access device 408 of vehicle 404 determines whether any of the listed mobile communications devices is within a range of a direct communication with the vehicle 404 (e.g., within a range from an antenna of the vehicle 404). In this example operation, it is assumed that the user profile of the user 410 does not yet exist in vehicle 404, or that the list of the mobile communications devices of the user profile maintained by vehicle 404 does not yet include the unique identifier of the mobile communications device 104.

At block 550, vehicle 404 sends a request for the unique identifiers of the mobile communications devices to the telematics service provider computer 102, and receives the unique identifiers in response to the request. In an embodiment, vehicle 404 sends the request as part of a request for the user profile, if vehicle 404 does not have a user profile of the user 410 yet. At block 555, the vehicle receives the list of unique identifiers from the telematics service provider computer 102 as part of the user profile of the user 410. Vehicle 404 stores the unique identifiers or the user profile in vehicle 404.

At block 560, vehicle 404, specifically the network access device 408, performs an automatic pairing process to allow the mobile communications device 104 to join the wireless network hosted by vehicle 404, without the user's manual involvement. The pairing process that vehicle 404 performs, unlike the pairing process vehicle 402 performs at block 510, may not require an associated set-up process. This is because the list of unique identifiers received from the telematics service provider computer 102 includes the unique identifier of the mobile communications device 104, which indicates that the mobile communications device 104 is verified to join the wireless network. Once the pairing process is successfully completed, the network access device 408 of vehicle 404 initiates a connection with the mobile communications device over the wireless network.

As can be appreciated in light of the disclosure, the order of operation is not limited to the sequential execution as illustrated in FIG. 5, but may be performed in one or more varying orders as applicable and in accordance with the present disclosure. For example, vehicle 402 may perform a pairing process at the block 510 before performing an authentication process at the block 505.

Technical effects include that a user of a mobile communications device does not have to repeat a set-up process for every enabled vehicle to join the mobile communications device in the wireless network hosted by a particular vehicle. This is because the enabled vehicles automatically complete a pairing process with the mobile communications device as long as the vehicles obtain the unique identifier of the communications device from a telematics service provider.

As described above, the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the present application.

What is claimed is:

1. A method of associating a second vehicle with a mobile communications device, comprising:
authenticating, by the second vehicle, a user with the second vehicle;
retrieving user information of the user from a remote server, the user information including an identifier of a mobile communications device, the identifier of the mobile communications device having been previously sent to the remote server by a first vehicle and stored at the remote server; and
automatically associating with the mobile communications device based on the retrieved user information.

2. The method of claim 1 further comprising maintaining a short-range wireless network, wherein the automatically associating comprises allowing the mobile communications device to join the short-range wireless network without the user's manual involvement.

3. The method of claim 2, wherein the short-range wireless network is based on Wi-Fi technology or Bluetooth technology.

4. The method of claim 1, wherein the user information further includes at least one additional identifier of a mobile communications device.

5. The method of claim 1, wherein the authenticating comprises obtaining and using biometric information of the user.

6. The method of claim 1, wherein the authenticating comprises receiving and using a username and a password.

7. The method of claim 1, wherein the identifier of the mobile communications device comprises at least one of a Bluetooth Address (BD_ADDR) and a media access control (MAC) address.

8. The method of claim 1, wherein the remote server is operated for a telematics service provider.

9. A system, comprising:
a computer processor; and
logic executable by the computer processor, the logic configured to implement a method, the method comprising:
receiving, from a first vehicle, user information including an identifier of a mobile communications device;
storing the user information;
receiving, from a second vehicle, a request for the user information; and
sending the second vehicle the user information,
wherein the second vehicle automatically associates with the mobile communications device based on the user information.

10. The system of claim 9, wherein the first vehicle sends the user information to the system after the first vehicle authenticates a user carrying the mobile communications device with the first vehicle.

11. The system of claim 9, wherein the user information further includes at least one additional identifier of a mobile communications device.

12. The system of claim 9, wherein the second vehicle sends the request to the system after the second vehicle authenticates a user carrying the mobile communications device has previously accessed the first vehicle and subsequently accesses the second vehicle.

13. The system of claim 9, wherein the mobile communications device is one of a smartphone, a personal media player, a tablet computer, a laptop computer, and a wearable electronic device.

14. The system of claim 9, wherein the identifier of the mobile communications device is one of a Bluetooth Address (BD_ADDR) and a media access control (MAC) address.

15. A method of facilitating automatic association of a second vehicle and a mobile communications device, comprising:
authenticating, by a first vehicle, a user with the first vehicle;
obtaining an identifier of the mobile communications device; and
sending user information including the identifier of the mobile communications device to a remote server,
wherein the remote server subsequently sends the user information to the second vehicle in response to receiving a request from the second vehicle,
wherein the second vehicle automatically associates with the mobile communications device when the user carrying the mobile communications device accesses the second vehicle.

16. The method of claim 15, wherein the second vehicle maintains a short-range wireless network, wherein the second vehicle automatically associates with the mobile communications device by allowing the mobile communications device to join the short-range wireless network without the user's manual involvement.

17. The method of claim 16, wherein the short-range wireless network is based on Wi-Fi technology or Bluetooth technology.

18. The method of claim 15, wherein the user information further includes at least one additional identifier of a mobile communications device.

19. The method of claim 15, wherein the mobile communications device is one of a smartphone, a personal media player, a tablet computer, a laptop computer, and a wearable electronic device.

20. The method of claim 15, wherein the identifier of the mobile communications device comprises at least one of a Bluetooth Address (BD_ADDR) and a media access control (MAC) address.
